(19) United States
(12) Patent Application Publication
(10) Pub. No.: US 2012/0094257 A1
(43) Pub. Date: Apr. 19, 2012

(54) REMOTE BRAILLE EDUCATION SYSTEM AND DEVICE

(75) Inventors: David Pillischer, River Vale, NJ (US); Peter J. Sullivan, Goffstown, NH (US)

(73) Assignee: ELECTRONIC BRAILLER, River Vale, NJ (US)

(21) Appl. No.: 13/286,114

(22) Filed: Oct. 31, 2011

Related U.S. Application Data
(63) Continuation-in-part of application No. 11/940,323, filed on Nov. 15, 2007, now abandoned.

(51) Int. Cl. G09B 21/00

(52) U.S. Cl. 434/113

(57) ABSTRACT

A remote Braille education system and device is disclosed. In one embodiment, a remote Braille education system includes a first computer system at a first location, second computer systems associated with visually impaired individuals at a second location, and a server. The first computer system includes an input device, and a display device, and each of the second computer systems includes an electronic Braille device(s). The input device is configured for communicating a first set of characters to the electronic Braille device via the server. The electronic Braille device is configured for embossing the first set of characters on a printing medium. Furthermore, the electronic Braille device is configured for transmitting a second set of characters inputted by the visually impaired individual(s) via the server. The display device is configured for displaying the second set of characters received from said one or more of the second computer systems.

### FIELD OF TECHNOLOGY

The present disclosure relates to the field of Braille system, and more particularly relates to a Braille education system and device.

### BACKGROUND

Distance learning is becoming a significant force as evidenced by the increasing number of educational institutions that are developing distance learning programs for their students. Distance learning schools typically offer courses as a supplement to students attending brick-and-mortar schools or to home schoolers. More specifically, the currently known distance learning systems provide distance learning programs for normal individuals. However, a challenge is faced in devising a distance learning system for individuals who are visually impaired as the visually impaired individuals are assisted to read and write using a Braille system.

The Braille system, devised in 1821 by Frenchmen Louis Braille, is a method that is widely used by visually impaired persons to read and write. Typically, each Braille character or cell is made up of six dot positions, arranged in a rectangle containing two columns of three dots each. A dot may be raised at any of the six positions to form sixty-four (26) combinations, including the combination in which no dots are raised. For reference purposes, a particular combination may be described by naming the positions where dots are raised, the positions being universally numbered 1 to 3, from top to bottom, on the left, and 4 to 6, from top to bottom, on the right. For example, dots 1-3-4 would describe a cell with three dots raised, at the top and bottom in the left column and on top of the right column, i.e., the letter m.

More recently, special Braille writers have been developed such as Braille typewriters and the like to write Braille characters. In Braille typewriters, Braille is printed on a recording medium, such as paper, using a hard Braille plate employed as a working die and a printing rod having a pin-shaped projection employed as a embossing die. Also, electronic Braille writers are introduced which utilizes solenoids permitting a simpler design for embossing Braille on a printing medium. However, the existing Braille writers may consume time significantly to print a fill line or page of Braille, as a character can contain as many as six raised dots. To overcome the above mentioned problems, computer driven Braille printing machine is introduced recently. Such machine requires a large rigid frame on which many solenoid-lever-pin combinations can be mounted for printing Braille characters. However, the large rigid frame and multitude of solenoids is cost prohibitive for individual consumers.

### SUMMARY OF THE INVENTION

This summary is provided to comply with 37 C.F.R. §1.73, requiring a summary of the invention briefly indicating the nature and substance of the invention. It is submitted with the understanding that it will not be used to interpret or limit the scope or meaning of the claims.

A remote Braille education system and device is disclosed. In one aspect, a remote Braille education system includes a first computer system associated with an instructor at a first location, a plurality of second computer systems associated with visually impaired individuals at a second location, and a server communicatively coupled to the first computer system and the plurality of second computer systems.

The first computer system includes an input device, and a display device, and each of the second computer systems includes an electronic Braille device. The input device is configured for communicating a first set of characters to the electronic Braille device associated with one or more of the second computer systems via the server. The electronic Braille device is configured for embossing the first set of characters on a printing medium at the second location in real time. Furthermore, the electronic Braille device is configured for transmitting a second set of characters inputted by the respective one of the visually impaired individuals via the server. The display device is configured for displaying the second set of characters received from said one or more of the second computer systems.

In another aspect, a portable electronic Braille device includes a Braille embosser for embossing a first set of Braille characters corresponding to a set of text characters on a printing medium associated with at least one visually impaired individual. The portable electronic Braille device also includes a Braille keyboard for enabling the at least one visually impaired individual to input a second set of Braille characters. The Braille embosser includes stepper motors, an eccentric shaft, and a print carriage with print heads. The Braille keyboard includes a supporting base and one or more keys pivotally mounted on the supporting base. The portable electronic Braille device may also include a universal serial bus (USB) port for communicatively connecting with a computer system. Additionally, the portable electronic Braille device may include a rechargeable battery for providing power to the Braille embosser, and a solar charger for recharging the rechargeable battery.

Other features of the embodiments will be apparent from the accompanying drawings and from the detailed description that follows.

### BRIEF DESCRIPTION OF THE VIEWS OF DRAWINGS

FIG. 1 is a block diagram of a remote Braille education system, according to one embodiment.

FIG. 2 illustrates a schematic representation of an electronic Braille device such as those shown in FIG. 1, according to one embodiment.

FIG. 3 illustrates a pictorial representation of the Braille keyboard such as those shown in FIG. 2, according to one embodiment.

FIG. 4 illustrates a cut away view of the Braille keyboard of FIG. 3, according to one embodiment.

FIG. 5 illustrates a pictorial representation of a key of the Braille keyboard, according to one embodiment.

FIG. 6 illustrates a top view of a print head used in the Braille embosser.

FIG. 7 illustrates a front view of the anvil of FIG. 2.

FIG. 8 is a cut away view along line A-A of FIG. 7.

FIG. 9 illustrates a screenshot view of a teacher agent displayed on a display device of a first computer system, according to one embodiment.

The drawings described herein are for illustration purposes only and are not intended to limit the scope of the present disclosure in any way.

### DETAILED DESCRIPTION

A thermally efficient light emitting diode (LED) lamp is disclosed. The following description is merely exemplary in nature and is not intended to limit the present disclosure, applications, or uses. It should be understood that throughout the drawings, corresponding reference numerals indicate like or corresponding parts and features.

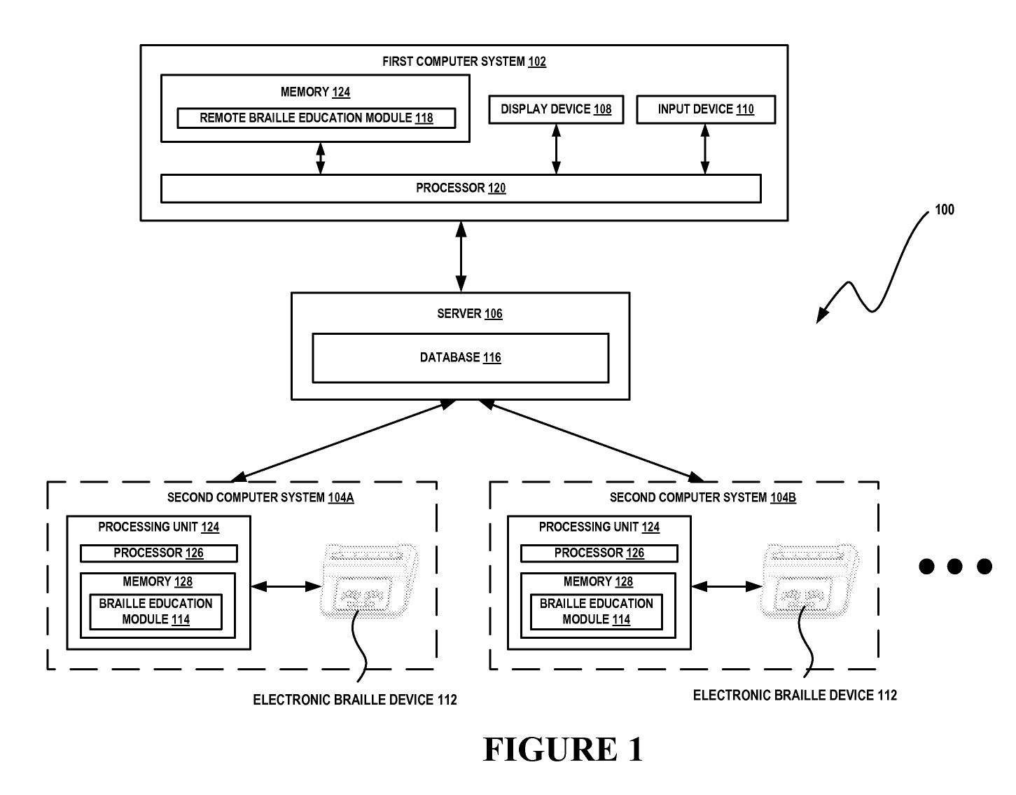

FIG. 1 is a block diagram of a remote Braille education system 100, according to one embodiment. In FIG. 1, the remote Braille education system 100 includes a first computer system 102, second computer systems 104A-N, and a server 106.

The first computer system 102 may be a desktop, laptop, or tablet associated with an instructor. The first computer system 102 includes a display device 108, such as monitor, and an input device 110 such as keyboard. Each of the second computer systems 104A-N includes an electronic Braille device 112 associated with a visually impaired individual. The first computer system 102 and the second computer systems 104A-N are remotely connected to the server 106 via the Internet (TCP/IP network).

The remote Braille education system 100 enables instructors to provide distance learning program to visually impaired individuals. In an exemplary operation, the instructor inputs a first set of characters using the input device 110 of the first computer system 102. For example, the first set of characters may include lessons or series of questions in a text format. The first computer system 102 transmits the first set of characters to the server 106. The server 106 communicates the first set of characters to the corresponding one or more electronic Braille devices 112. In one embodiment, the server 106 transmits the first set of characters to the one or more Braille devices 112 associated with individuals who are online and selected by the instructor for participating in the teaching session. The server 106 includes a database 116 containing a list of instructors, a list of registered individuals and a list of online registered individuals. Based on the information in the database 116, the instructor associated with the teaching session may select one or more of the online registered individuals and transmits the tests, lessons, questions, etc. to the selected one or more electronic Braille devices 112 during the teaching session via the server 106. Moreover, the selected electronic Braille devices 112 may be located in a classroom or in classrooms at various remote locations.

Each of the electronic Braille devices 112 includes a Braille embosser which embosses the first set of characters received from the server on a printing medium, such as a paper, at the visually impaired individual's location in a Braille format. The Braille embosser is designed for embossing the first set of characters in Braille format without disturbing the other individuals. In other words, the Braille embosser enables noise less embossing of the first set of characters on the printing medium unlike the conventional Braille embosser.

In one embodiment, the electronic Braille devices 112 includes a remote Braille education module 114 which translates the first set of characters in the text format into a Braille format and then embosses on the printing medium. In an alternate embodiment, the remote Braille education module 114 converts the first set of characters in the text format to a speech format without embossing on the printing medium. This facilitates the instructor to prepare a questionnaire or lessons in plain text format and transmit to the Braille devices 112 over the Internet. In one exemplary implementation, each of the second computer systems 104A-N includes a processing unit 124 coupled to the electronic Braille device 112. The processing unit 124 may include a processor 126 and memory 128, where the memory 128 includes the remote Braille education module 114 in the form of machine-readable instructions which are executed by the processor to perform a desired function(s) such as conversion the first set of Braille characters in Braille format. The electronic Braille device 112 may include a universal serial bus (USB) port for communicatively connecting with the processing unit 124 via a USB interface (not shown).

Alternatively, the processing unit 124 and the electronic Braille device 112 can be connected via any other communication interfaces pertinent in the art. Additionally, the processing unit 124 is capable of communicating with the server 106 via the Internet. In alternate exemplary implementation, each electronic Braille device 112 may include a processor and memory (not shown in FIG. 1), where the memory includes the remote Braille education module 114 in the form of machine-readable instructions.

Further, each electronic Braille device 112 enables the visually impaired individual to input a second set of characters in a Braille format using a Braille keyboard 204 provided on the electronic Braille device 112. For example, the second set of characters may contain answers to the series of questions provided by the instructor. The said each electronic Braille device 112 then transmits the second set of characters in the Braille format to the first computer system 102 via the server 106. The first computer system 102 includes a remote Braille education module 118 which translates the second set of characters in the Braille format into a text format.

The remote Braille education module 118 further displays the second set of characters in the text format on the display device 108 at the instructor's location. For example, the remote Braille education module 118 may be stored in memory 122 in the form of machine-readable instructions that when executed by a processor 120, result in translation of the second set of characters to text format. In some embodiments, the second set of characters inputted by each visually impaired individual are translated and displayed as and when the individuals' input the second set of characters using the Braille keyboard 204. Alternatively, the remote education module 112 enables the visually impaired individuals to store the second set of characters in the server 106 such that the instructor can access file(s) containing the second set of characters a later point of time. Additionally, the remote Braille education module 114 enables the visually impaired individuals to print the second set of characters in a text format and/or Braille format on a printer connected the electronic Braille device 112.

Furthermore, the remote Braille education modules 114 and 118 enable speech based communication between the instructor and the one or more visual impaired individuals during a teaching session. It is appreciated that the speech based communication or voice communication is enabled via a micro-phone and headphone provided in the first computer system 104 and each of the second computer systems 104A-N. In some embodiments, each electronic Braille device 112 is provided with communication ports for plugging-in micro-phone and head phone pins in order to enable speech communication with the instructor. Furthermore, each electronic Braille device 112 includes a rechargeable battery for supplying power for operation of the electronic Braille device 112. Additionally, each electronic Braille device 112 may include a battery charger (e.g., solar charger or grid charger) for replenishing charge of the rechargeable battery.

In one exemplary implementation, the remote Braille education system 100 provides real time full duplex or half duplex conferencing and monitoring of the visually impaired individuals. The instructor can transmit lessons and documents to the individuals' location. When the instructor sends a computer command, the electronic Braille device 112 embosses Braille characters on a paper at the individual's location. The visually impaired individual can read the questions in the document, and answers the questions using the Braille keyboard 204. Accordingly, the answers are displayed on the display device 108 in a text format. The instructor can read the answers for the questions from the display device 108.

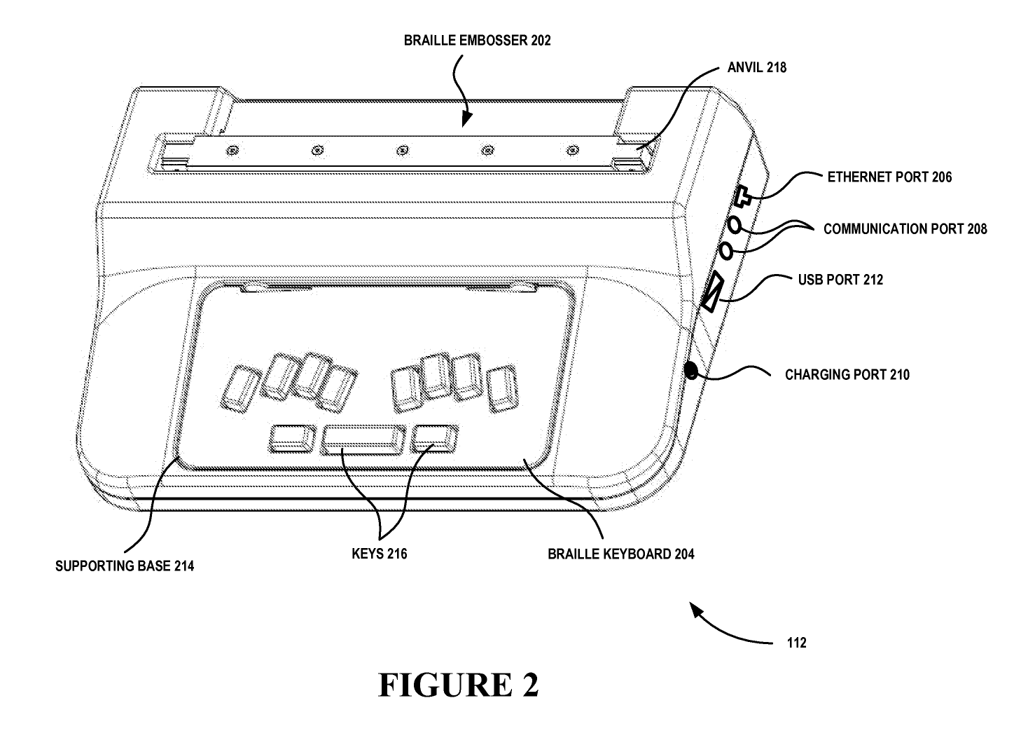

FIG. 2 illustrates a schematic representation of the electronic Braille device 112 such as those shown in FIG. 1, according to one embodiment. The electronic Braille device 112 acts as an input as well as output device for visually impaired individual and is user friendly, quiet, economical, and portable. The electronic Braille device 112 includes a Braille embosser 202, a Braille keyboard 204, an Ethernet port 206, communication ports 208, a charging port 210, and an USB port 212.

The Braille embosser 202 includes stepper motors, an eccentric shaft (e.g., with a cam and lobe configuration), and a pint carriage containing two print heads. Each of the print heads consists of one of the two columns of Braille character. In an exemplary embossing operation, the stepper motors provides predetermined rotational movement to the eccentric shaft. The rotational movement of the eccentric shaft causes the lobe on the eccentric shaft to raise a print carriage containing the prints heads. Consequently, raised pins of the print heads are pressed into the grooves of the anvil 218, leading to embossing the first set of Braille characters on the printing medium. It can be noted that, the use of eccentric shaft in the Braille embosser 202 prevents wear and tear of the components of the Braille embosser 202.

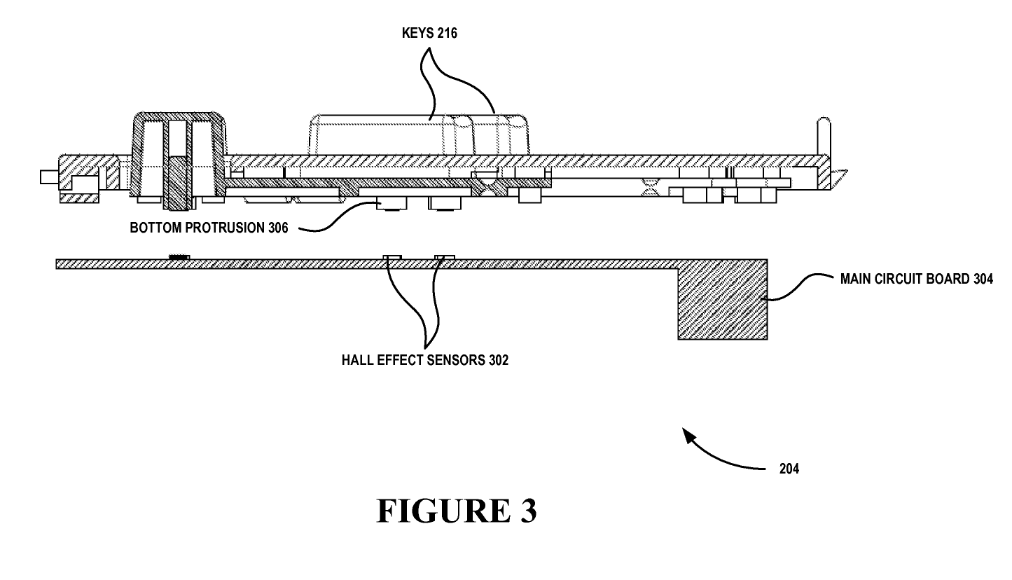

The Braille keyboard 204 includes a supporting base 214 and keys 216 pivotally mounted on the supporting base 214 using a living hinge. The Braille keyboard 204 also consists of sensors 302 located on a main circuit board 304 as shown in FIG. 3. The sensors 302 may be hall-effect sensors positioned with respect to the respective keys 216. Each of the keys 216 has bottom protrusion 306 extending downwardly from the said bottom. The bottom protrusion consists of a magnet(s) 502 attached thereon, as illustrated in FIG. 5. Thus, the sensor 302 on the main circuit board 304 registers a Braille character inputted by the visually impaired individual when the corresponding magnet comes near to the sensor 302 (as the visually impaired individual presses the respective key).

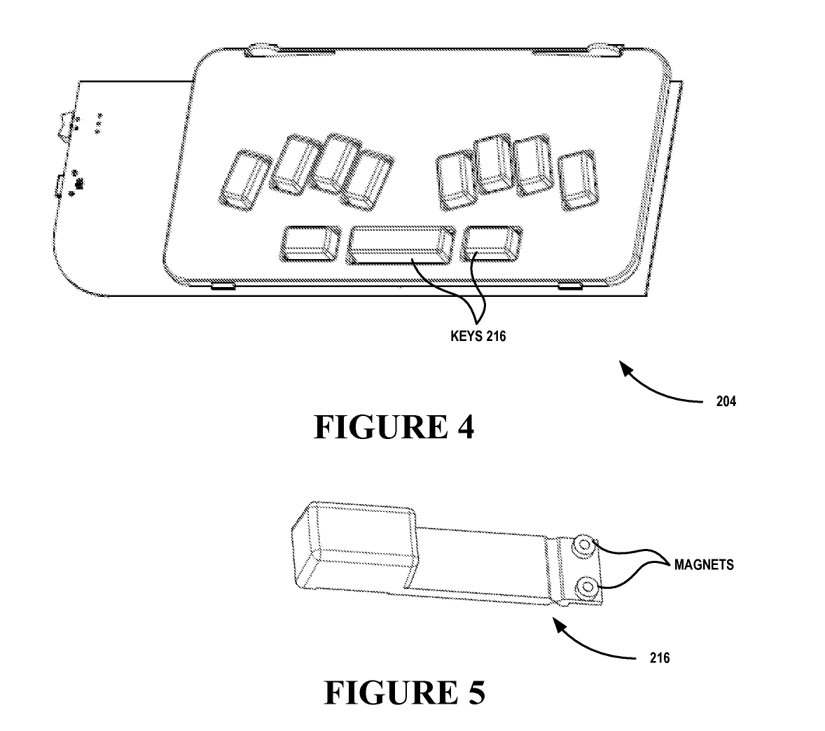

As shown in FIG. 4, the Braille keyboard 204 fits in depression in a top case of the electronic Braille device 112. This facilitates a user to access the Braille keyboard and the case under the Braille keyboard 204. In case of dirt or spill, the case under the Braille keyboard 204 can be wiped off. It is appreciated that, the Braille keyboard 206 emulates functionalities of a standard computer keyboard.

The Ethernet port 206 enables the electronic Braille device 112 to be connected with a local area network connection. Alternatively, the electronic Braille device 112 may also have wireless capabilities to connect wirelessly with the Internet router. The electronic Braille device 112 may also include the communication ports 208 for connecting micro-phone and head phone to enable voice communication during the teaching session. Additionally, the electronic Braille device 112 includes a charging port for charging the rechargeable batteries contained therein. Moreover, the electronic Braille device 112 includes the USB port 212 for enabling connection with the processing unit 124 using a USB cable. One skilled in the art will realize that the electronic Braille device 112 can also be used as standalone Braille typewriter.

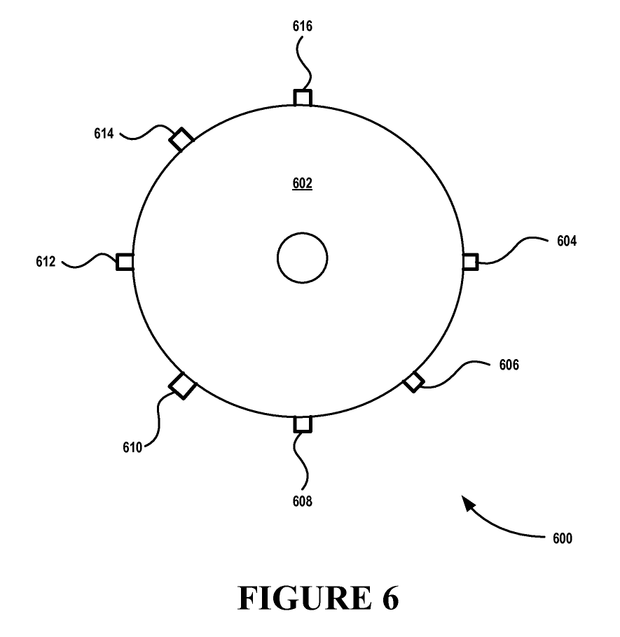

FIG. 6 illustrates a top view of a print head 600 used in the Braille embosser 202. Body 602 of the print head 600 has a number of pin locations 604-616 about the periphery equal to 2n−1 where n equals the number of pins or the number of dots in the Braille cell or a single column of the Braille cell. One of possible combinations is where no pins are raised thus one location can be subtracted. Thus, where a single column of a standard Braille cell is printed, there are 2³−1=7 required locations about the periphery each having up to three pins.

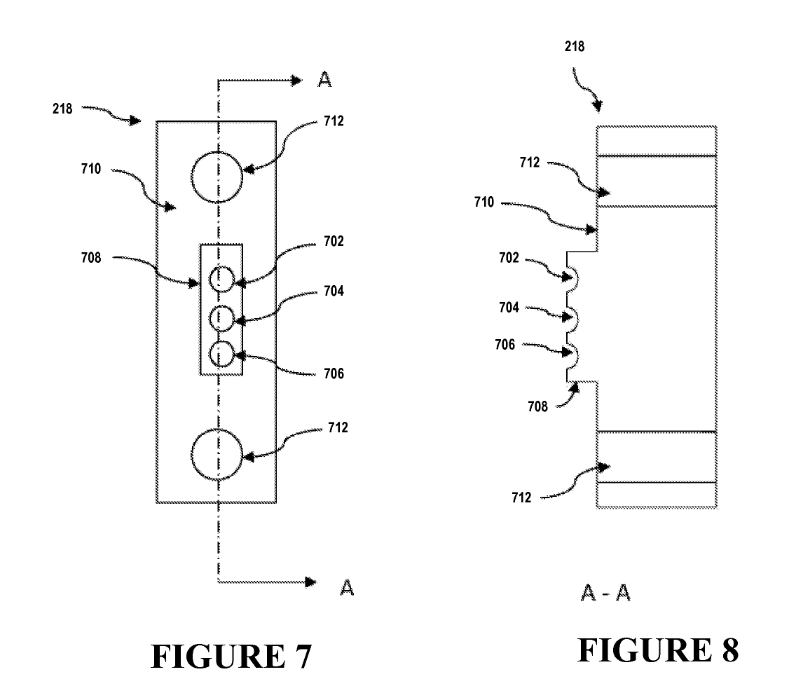

FIG. 7 illustrates a front view of the anvil 218 of FIG. 2. The anvil 218 has three dots 702, 704 and 706 in the top of a seat 708. The seat 708 sets the divots above the lower body 710 of the anvil 218. The body 710 has many holes 712 to secure to a cam of the eccentric shaft for moving in contact with the paper during embossing of the second set of Braille characters. The divots are aligned with the pins 604-616 on the body 502 of the print head 500. The divots 702, 704, and 706 form the top of a raised dot.

FIG. 8 is a cut away view along line A-A of FIG. 7. As illustrated, the divots 702, 704, and 706 are semicircular in depth and are formed only a short distance into the seat 708. The divots 702, 704 and 706 are defined geometrically by the International Braille Standards.

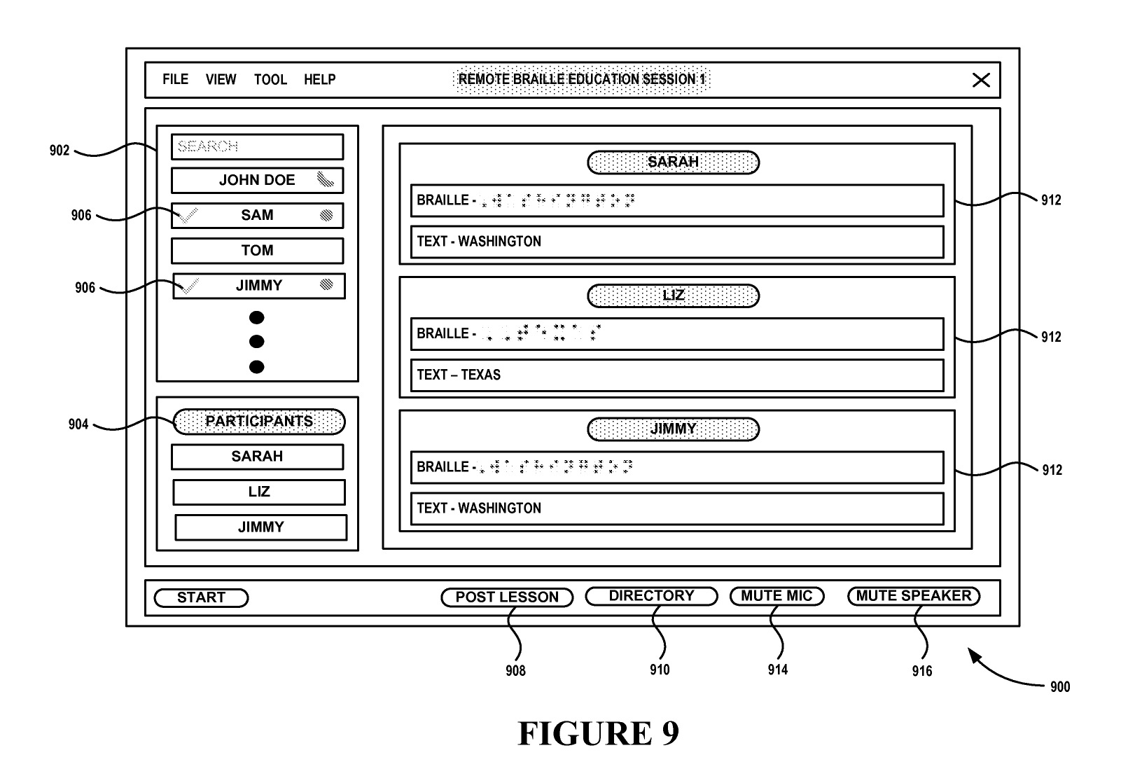

FIG. 9 illustrates a screenshot view of a teacher agent 900 displayed on the display device 108 of the first computer system 102, according to one embodiment. The teacher agent 900 displays a list of total visually impaired individuals associated with the instructor 902 and list of individuals participating in current session 904. For example, the list of total individuals 902 displays names of individuals along with online/offline status. The teacher agent 900 provides an option 906 to select the number of individuals selected for participating in the teaching session. In other words, the instructor is enabled to select the electronic Braille devices 112 for embossing the lesson/questions. The teacher agent 900 also allows the instructor to post lesson/questionnaire in text format to the selected individuals using a post tab 908. Once the lesson/questionnaire is posted, the lesson/questionnaire is embossed on a paper in real time in a Braille format using the selected electronic Braille device(s) 112 at individuals' location.

When the selected individuals answer the questionnaire, the teacher agent 900 enables the instructor to access answers associated with each individual stored on the server 106 by selecting directory button 910. In one embodiment, the answers are translated from a Braille format to a text format prior to displaying on the display device 108. All the work of the visually impaired individuals is stored in the server 106 till the point the instructor erases it.

The teacher agent 900 also displays Braille-text line characters inputted by the individuals using the electronic Braille device 112 in the Braille-text line field 912. The Braille-text line field 912 displays a line of translated text corresponding to current line of Braille characters entered by the individual(s). Further, the teacher agent 900 also provides a micro-phone mute/un-mute button 914, and a speaker mute/un-mute button 916 for operating the micro-phone and speaker respectively. In accordance with the foregoing description, one can envision that the instructor may use an electronic Braille device for providing first set of characters to the visually impaired individuals when the instructor is visually challenged. It is understood that, the second set of characters sent by the visually impaired individuals is embossed at the instructor's location on a printing medium in a Braille format or delivered as a voice output.

It will be recognized that the above described invention may be embodied in other specific forms without departing from the spirit or essential characteristics of the disclosure. Thus, it is understood that, the invention is not to be limited by the foregoing illustrative details, but it is rather to be defined by the appended claims.

What is claimed is:

1. A remote Braille education system comprising:
a first computer system associated with an instructor at a first location comprising:
an input device; and
a display device;
a plurality of second computer systems associated with visually impaired individuals at a second location, wherein each of the plurality of second computer systems comprises:
an electronic Braille device; and
a server communicatively coupled to the first computer system and the plurality of second computer systems, wherein the first computer system is configured for communicating the first set of characters inputted by the instructor via the input device to the electronic Braille device of one or more of the plurality of second computer systems via the server, and wherein the electronic Braille device is configured for embossing the first set of characters on a printing medium at the second location in real time and for transmitting a second set of characters inputted by the respective one of the visually impaired individuals via the server, and wherein the display device is configured for displaying the second set of characters received from said one or more of the plurality of second computer systems.

2. The system of claim 1, wherein the first set of characters is in a text format.

3. The system of claim 2, wherein said each of the plurality of second computer systems comprises:
a processing unit communicatively coupled to the electronic Braille device comprising:
a processor; and
memory coupled to the processor, wherein the memory includes a first remote Braille education module for converting the first set of characters in text format into at least one of Braille format and speech format.

4. The system of claim 3, wherein the electronic Braille device comprises a Braille embosser for embossing the first set of characters on the printing medium, wherein the Braille embosser comprises at least one stepper motor, an eccentric shaft, and printing carriage with print heads for embossing the first set of characters in the Braille format.

5. The system of claim 1, wherein the Braille device comprises a Braille keyboard for enabling the respective one of the visually impaired individuals to input the second set of characters in a Braille format, wherein the Braille keyboard comprises a supporting base and one or more key pivotally mounted on to the supporting base using a living hinge.

6. The system of claim 1, wherein the first computer system further comprises:
a processor; and
memory coupled to the processor; wherein the memory includes a second remote Braille education module for translating the second set of characters received from the one or more of the plurality of second computer systems in a text format.

7. The system of claim 6, wherein the second remote Braille education module enables selection of the Braille device associated with the one or more of the visually impaired individuals for embossing the first set of characters.

8. The system of claim 6, wherein the second remote Braille education module is configured for displaying a list of visually impaired individuals in offline mode and online mode on the display device.

9. The system of claim 8, wherein the first remote Braille education module is configured for enabling the instructor to communicate with one or more visually impaired individuals using speech.

10. The system of claim 1, wherein the second remote Braille education module is configured for enabling respective one of the visually impaired individuals to communicate with the instructor using speech.

11. The system of claim 1, wherein said each of the plurality of second systems comprises a storage module for storing the second set of characters in the server.

12. A portable electronic Braille device comprising:
a Braille embosser for noise less embossing a first set of Braille characters corresponding to a set of text characters on a printing medium associated with at least one visually impaired individual; and
a Braille keyboard for enabling the at least one visually impaired individual to input a second set of Braille characters, wherein the Braille embosser comprises stepper motors, an eccentric shaft and a print carriage with print heads, and wherein the Braille keyboard comprises a supporting base and one or more keys pivotally mounted on the supporting base.

13. The device of claim 11, further comprising at least one universal serial bus (USB) port for communicatively connecting with a computer system.

14. The device of claim 11, further comprising a rechargeable battery for providing power to the Braille embosser.

15. The device of claim 14, further comprising a solar charger for recharging the rechargeable battery.

16. The device of claim 11, wherein the stepper motors are configured to rotate the eccentric shaft such that raised pins on respective print heads mounted on the eccentric shaft are pressed into grooves of an anvil resulting in embossing the first set of Braille characters on the printing medium.

17. The device of claim 11, wherein each of the one or more keys comprises a magnet.

18. The device of claim 17, wherein the Braille keyboard comprises one or more sensors located on a main circuit board and positioned with respect to the one or more keys.

19. The device of claim 17, wherein the one or more sensors are configured for sensing movement of the respective one or more keys corresponding to the second set of Braille characters inputted by the at least one visually impaired individual.

20. The device of claim 17, further comprising:
a processor; and
memory coupled to the processor, wherein the memory includes a remote Braille education module configured for:
converting the set of text characters into the set of Braille characters prior to embossing on the printing medium; and
enabling said at least one visually impaired individual to communicate with the instructor using speech.
